(19) United States
(12) Patent Application Publication
(10) Pub. No.: US 2020/0309318 A1
(43) Pub. Date: Oct. 1, 2020

(54) Adjustable Appliance Spacer Device

(71) Applicant: Kyle Gabbard, Vero Beach, FL (US)

(72) Inventor: Kyle Gabbard, Vero Beach, FL (US)

(21) Appl. No.: 16/829,066

(22) Filed: Mar. 25, 2020

Related U.S. Application Data
(60) Provisional application No. 62/823,097, filed on Mar. 25, 2019.

(51) Int. Cl. F16M 13/02; D06F 39/12; D06F 58/20

(52) U.S. Cl. CPC F16M 13/022; D06F 39/125; F25D 23/10; F16M 2200/028; D06F 58/20

(57) ABSTRACT

An adjustable appliance spacer device. The adjustable appliance spacer device is defined by an elongated member. The elongated member defines a first end and a second end. The first end is defined on an opposing side of the second end. A first arm extends perpendicularly from the first end of the elongated member. A second arm extends perpendicularly from the second end of the elongated member. The first arm and the second arm are parallel to each other. Furthermore, the first arm and the second arm are independently adjustable in length, such that the distance between a wall and an appliance can be defined.

### CROSS REFERENCE TO RELATED APPLICATIONS

This application claims the benefit of U.S. Provisional Application No. 62/823,097 filed on Mar. 25, 2019. The above identified patent application is herein incorporated by reference in its entirety to provide continuity of disclosure.

### BACKGROUND OF THE INVENTION

The present invention relates to an adjustable appliance spacer device. More specifically, the present invention relates to a mechanical device designed to define a desired space between a wall and a home appliance.

Home appliances such as refrigerators, dryers and washers have provided individuals with conveniences that were once thought impossible. Most of these devices comprise a series of inlets that provide power and resources to the appliance, as well as a series of outlets for exhaust or the release of other byproducts of the appliance operation. When these inlets and outlets become obstructed, however, the operation of the appliance can be affected. For example, when the exhaust hose of a dryer makes contact with a nearby wall, it can cause the hose to become kinked. When an exhaust hose, or similar outlet, becomes kinked, it is more likely to become clogged or otherwise altered. In addition to the negative effects upon the efficiency of the appliance, it can cause the appliance to become significantly damaged to the extent that it may require replacement or costly repairs. Furthermore, in the specific case of exhaust, the likelihood of a fire increases. In other cases, such as with appliances that require the use of water, water lines can cause leaks or flooding when they are kinked or otherwise damaged.

Many individuals will attempt to combat the risk of inlets or outlets becoming kinked or damaged by placing their appliances at a sufficient distance from the wall next to the location where the appliance is installed. This is not always practical in situations where there is a limited amount of space, such as longer, more narrow rooms. Additionally, some appliances, such as washers and dryers, may become displaced during their operation.

Some appliances are now equipped with integrated mechanisms that are configured to define space between walls and appliances. These mechanisms, however, can be confusing and complicated. Furthermore, the adjustability of these mechanisms is typically either limited significantly or impacts the primary functionality of the appliance itself. These devices limit the ability of the owner to install the appliance in certain locations, such as against uneven or curved walls.

Therefore, there is a defined need amongst known devices for a device that will assist individuals in defining a desired space between a wall and an appliance, such as to prevent damage to the wall or to the appliance itself.

### SUMMARY OF THE INVENTION

In view of the foregoing disadvantages inherent in the known types of household spacing devices now present in the prior art, the present invention provides an adjustable appliance spacer device wherein the same can be utilized for providing convenience for the user when providing a mechanism for defining a space between a wall and an appliance, such as a refrigerator a washer or a dryer.

The present system defines an adjustable appliance spacer device. The adjustable appliance spacer device comprises an elongated member. The elongated member defines a first end and a second end. The first end is defined on an opposing side of the second end. A first arm extends perpendicularly from the first end of the elongated member. A second arm extends perpendicularly from the second end of the elongated member. The first arm and the second arm are parallel to each other. Furthermore, the first arm and the second arm are independently adjustable in length.

In some embodiments, the first arm and the second arm are adjustable in length by being telescopic in nature. As such, an individual may freely and easily manipulate the length of the first arm and the second arm.

In other embodiments, the adjustable appliance spacer device further comprises an installation frame disposed on a distal end of each of the first arm and the second arm. As such, the adjustable appliance spacer device can be more easily and conveniently installed upon a wall.

In further embodiments, the adjustable appliance spacer device further comprises at least one pad externally disposed on the elongated member opposite the first arm and the second arm.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the adjustable appliance spacer device.

FIG. 2 shows a perspective view of an embodiment of the adjustable appliance spacer device in use.

FIG. 3 shows a side view of an embodiment of the adjustable appliance spacer device in use.

### DETAILED DESCRIPTION OF THE INVENTION

Reference is made herein to the attached drawings. Like reference numerals are used throughout the drawings to depict like or similar elements of the adjustable appliance spacer device. The figures are intended for representative purposes only and should not be considered to be limiting in any respect.

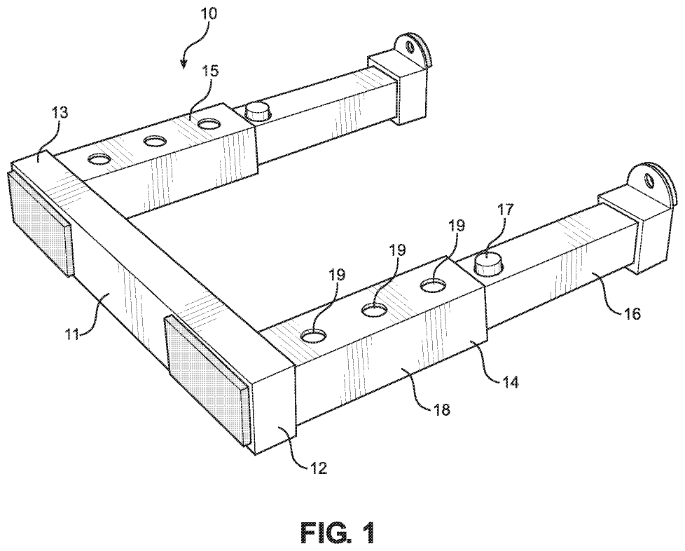

Referring now to FIG. 1, there is shown a perspective view of an embodiment of the adjustable appliance spacer device. The adjustable appliance spacer device 10 comprises an elongated member 11. The elongated member 11 defines a first end 12 and a second end 13. The first end 12 is disposed on an opposing side of the elongated member 11 opposite the second end 13. In the illustrated embodiment, the elongated member 11 defines a flat base. As such, the elongated member 11 may rest evenly on a flat surface, such as a floor.

The elongated member 11 comprises a first arm 14. The first arm 14 extends perpendicularly from the first end 12 of the elongated member 11. In the illustrated embodiment, the first arm 14 is inset from the first end 12, such that the first arm 14 is defined entirely within the length of the elongated member 11. The elongated member 11 further comprises a second arm 15. The second arm 15 extends perpendicularly from the second end 13 of the elongated member 11. In the illustrated embodiment, the second arm 15 is inset from the second end 13, such that the second arm 15 is defined entirely within the length of the elongated member 11. Furthermore, in some embodiments, the first arm 14 and the second arm 15 are inset the same length from the first end 12 and the second end 13.

As demonstrated, in the illustrated embodiment, the first arm 14 and the second arm 15 are parallel to each other. As such, force applied to the elongated member 11 will be exerted equally upon the wall or vertical structure by the first arm 14 and the second arm 15. In the illustrated embodiment, the first arm 14 and the second arm 15 each define a 90 degree angle between itself and the elongated member 11. In some embodiments, the elongated member 11, the first arm 14 and the second arm 15 define a rectangular cross-section. As such, each component may rest evenly on a flat surface, such as a floor.

The first arm 14 and the second arm 15 are adjustable in length. As such, the user may define a length between an appliance and a vertical structure, such as a wall. The first arm 14 and the second arm 15 may be adjustable in length via any suitable means. For example, the first arm 14 and the second arm 15 may be telescopic in configuration. In such embodiments, the first arm 14 and the second arm 15 comprise a rod 16. The rod 16 comprises a ball détente 17. The ball détente 17 is spring-biased in an outward position. Furthermore, in these embodiments, the first arm 14 and the second arm 15 comprise a sleeve 18. The sleeve 18 comprises a plurality of apertures 19. The plurality of apertures 19 are dimensioned to receive the ball détente 17 therethrough. As such, the user may adjust the length of the first arm 14 and the second arm 15 by depressing the ball détente 17 and sliding the rod 16 in the direction of the elongated member 11. In some embodiments, the first arm 14 and the second arm 15 are of a lesser diameter than the elongated member 11. As such, the first arm 14 and the second arm 15 will not make contact with the ground when their lengths are adjusted, preventing damage to the floor or other surface.

In the illustrated embodiment, the first arm 14 and the second arm 15 are independently adjustable in length. As such, the adjustable appliance spacer device 10 may be installed upon uneven vertical surfaces or walls. For example, some walls may define sections of greater width than other sections. As such, it is desirable to provide a first arm 14 and a second arm 15 that do not need to be of an identical length. The first arm 14 and the second arm 15 may, however, be of an identical length if it is necessary for the adjustable appliance spacer device 10 to be mounted upon a vertical surface of an identical width.

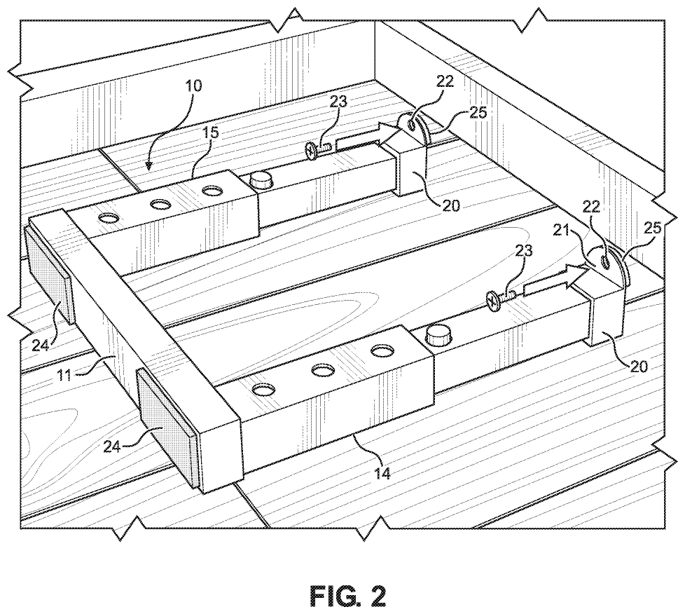

Referring now to FIG. 2, there is shown a perspective view of an embodiment of the adjustable appliance spacer device in use. In the illustrated embodiment, each of the first arm 14 and the second arm 15 of the adjustable appliance spacer device 10 further comprise an installation frame 20 thereon. Each of the installation frames 20 is disposed on the distal end of the first arm 14 and the second arm 15 opposite the elongated member 11. The installation frames 20 are configured to assist the user in installing the adjustable appliance spacer device 10 upon a vertical surface, such as a wall. In the specific embodiment shown, the installation frame 20 comprises a semi-circular tab 21. The semi-circular tab 21 is configured to be free of corners, such as to reduce points in the installation frame 20 that could pierce or otherwise damage the wall or vertical surface.

The installation frames 20 further comprise a cavity 22. In embodiments characterized by a semi-circular tab 21, the cavity 22 is dimensioned to receive a fastener 23 therethrough. The cavities 22 are of any suitable configuration for receiving a fastener 23. For example, the cavities 22 may define a threaded interface or a smooth interface. In the illustrated embodiment, the cavities 22 are configured to receive a threaded screw therethrough. As such, the cavities 22 are of a lesser perimeter than the head of the threaded screw.

In the illustrated embodiment, the elongated member 11 further comprises at least one pad 24 disposed on an external surface thereof. The pads 24 are disposed on a side of the elongated member 11 opposite the first arm 14 and the second arm 15, such that an appliance engaged therewith can be protected from damage. Specifically, appliances that utilize force when in motion, such as washers and dryers, may become damaged if placed in direct contact with a durable material, such as a metal. As such, the pads 24 are made of a relatively soft material, such as rubber, to reduce the force exerted between the appliance and the adjustable appliance spacer device 10. Additionally, in some embodiments, each installation frame 20 further comprises an installation pad 25 disposed on an outer surface of the installation frame 20 that is engaged with the wall or vertical surface. As such, damage to the wall or vertical surface is reduced as the installation pad 25 can absorb any impacts between the adjustable appliance spacer device 10 and the wall or vertical surface.

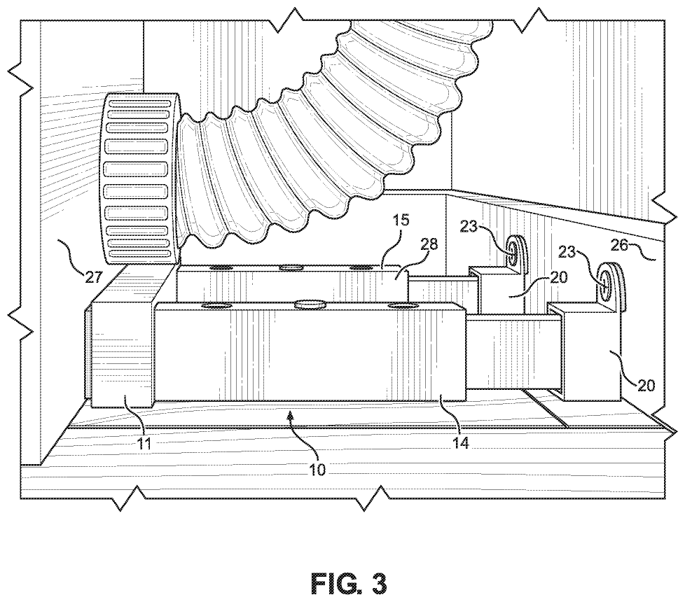

Referring now to FIG. 3, there is shown a side view of an embodiment of the adjustable appliance spacer device in use. In use, the adjustable appliance spacer device 10 is installed upon a vertical surface, such as a wall 26. Specifically, in the illustrated embodiment, the installation frames 20 of the first arm 14 and the second arm 15 are secured to the wall 26 via a pair of fasteners 23. The first arm 14 and the second arm 15 are set to a desired length by the user. In the illustrated embodiment, the first arm 14 and the second arm 15 are set to an identical length because the wall 26 upon which the adjustable appliance spacer device 10 is mounted is flat along the length of the elongated member 11.

The elongated member 11 is in contact with a rear surface of an appliance 27. As such, a space 28 is defined between the appliance 27 and the wall 26. The space 28 is configured to allow for free operation of the inlet and outlet cords and vents to operate. The dimensions of the space 28 are adjustable by the user, such that the space 28 is sufficient to accommodate the required amount for a specific appliance 27. Furthermore, in the illustrated embodiment, the elongated member 11 is of a sufficient height to prevent interference with the inlet and outlet cords and vents.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An adjustable appliance spacer device, comprising:
an elongated member defining a first end and a second end;
the elongated member comprising a first arm extending perpendicularly from the first end of the elongated member;
the elongated member comprising a second arm extending perpendicularly from the second end of the elongated member;
the first arm and the second arm being parallel to each other;
the first arm and the second arm being independently adjustable in length.

2) The adjustable appliance spacer device of claim 1, wherein the first arm and the second arm are telescopic in configuration.

3) The adjustable appliance spacer device of claim 2, wherein the first arm and the second arm comprises a ball detente disposed on a rod, wherein the ball detente corresponds to a plurality of apertures on a sleeve of each of the first arm and the second arm.

4) The adjustable appliance spacer device of claim 1, wherein an installation frame is disposed on a distal end of each of the first arm and the second arm.

5) The adjustable appliance spacer device of claim 4, wherein the installation frame comprises an installation pad disposed on an outer surface thereof.

6) The adjustable appliance spacer device of claim 4, wherein the installation frame comprises a cavity dimensioned to receive a fastener.

7) The adjustable appliance spacer device of claim 4, wherein the installation frame comprises a semi-circular tab defining a cavity therethrough, the cavity dimensioned to receive a fastener.

8) The adjustable appliance spacer device of claim 1, wherein the elongated member comprises at least one pad disposed externally opposite the first arm and the second arm.

9) The adjustable appliance spacer device of claim 1, wherein the first arm and the second arm are of a lesser perimeter than the elongated member.

10) The adjustable appliance spacer device of claim 1, wherein the elongated member, the first arm and the second arm are of a rectangular cross-section.

11) The adjustable appliance spacer device of claim 1, wherein the first arm and the second arm are of an identical length.

12) The adjustable appliance spacer device of claim 1, wherein the elongated member defines a flat base.
